(19) United States
(12) Patent Application Publication
(10) Pub. No.: US 2021/0256947 A1
(43) Pub. Date: Aug. 19, 2021

(54) ACOUSTIC CORES AND METHODS FOR SPLICING ACOUSTIC CORES

(71) Applicant: General Electric Company, Schenectady, NY (US)

(72) Inventors: Wendy Wenling Lin, Montgomery, OH (US); David Herman, Beavercreek, OH (US); James Duvall Bollacker, Scotia, NY (US)

(21) Appl. No.: 16/791,579

(22) Filed: Feb. 14, 2020

(51) Int. Cl. G10K 11/172; F02C 7/045; F02K 1/34; B29C 64/153

(52) U.S. Cl. CPC G10K 11/172; F02C 7/045; B29L 2031/7504; B29C 64/153; B64D 33/06

(57) ABSTRACT

Acoustic cores and methods for forming and for assembling acoustic cores are provided. For example, an acoustic core of a gas turbine engine comprises a first attenuation section having a first plurality of attenuation members and a first mating wall having a planar first mating surface. The first mating wall is integrally formed with at least a portion of the first plurality of attenuation members and defines a portion of a perimeter of the first attenuation section. A method for forming an acoustic core comprises additively manufacturing a first attenuation section of the acoustic core, which comprises a first plurality of attenuation members and a first mating wall that are integrally formed as a single unit. A method for assembling an acoustic core comprises applying an adhesive to mating surfaces of first and second attenuation sections and pressing together the mating surfaces to join the first and second attenuation sections.

### FEDERALLY SPONSORED RESEARCH

This invention was made with government support under contact number DTFAWA-15-A-80013 of the United States Federal Aviation Administration. The government may have certain rights in the invention.

### FIELD

The present subject matter relates generally to noise attenuation structures. More particularly, the present subject matter relates to acoustic cores for gas turbine engines.

### BACKGROUND

Aircraft engine noise is a significant problem in high population areas and noise-controlled environments. The noise is generally composed of contributions from various source mechanisms in the aircraft, with fan noise typically being a dominant component of engine noise at take-off and landing. Fan noise generated at the fan of the aircraft engine propagates through the engine intake and exhaust duct and then is radiated to the outside environment. Acoustic liners are known to be applied on the internal walls of the engine's casing and hub to attenuate the fan noise propagating through the engine ducts. Acoustic liners also may be applied to other portions of the engine to attenuate noise from other engine components or may be applied to other portions of the aircraft to attenuate noise from the engine and/or other aircraft components. Further, the principles of acoustic liners may apply generally to noise attenuation structures for other applications.

Commonly, an acoustic core or liner design may be relatively large, such that the acoustic core may be made from several sections or portions. The sections or portions of the acoustic core typically are spliced together with a foaming adhesive, which creates an acoustically inactive seam. Mechanical joints are another typical mechanism for joining acoustic core sections, which can be difficult to manufacture and/or difficult to assemble. Thus, splicing acoustic core section using standard processes can be labor intensive and reduce acoustic capability.

Accordingly, improvements to acoustic cores and methods, processes, and apparatus for forming and assembling acoustic cores that help overcome these issues would be useful.

### BRIEF DESCRIPTION

Aspects and advantages of the invention will be set forth in part in the following description, or may be obvious from the description, or may be learned through practice of the invention.

In one exemplary embodiment of the present subject matter, an acoustic core of a gas turbine engine is provided. The acoustic core comprises a first attenuation section having a first plurality of attenuation members and a first mating wall having a planar first mating surface. The first mating wall is integrally formed with at least a portion of the first plurality of attenuation members. The first mating wall defines a portion of a perimeter of the first attenuation section.

In another exemplary embodiment of the present subject matter, a method for forming an acoustic core of a gas turbine engine is provided. The method comprises depositing a layer of additive material on a bed of an additive manufacturing machine and selectively directing energy from an energy source onto the layer of additive material to fuse a portion of the additive material and form a first attenuation section of the acoustic core. The first attenuation section comprises a first plurality of attenuation members and a first mating wall. The first plurality of attenuation members and the first mating wall are integrally formed as a single unit.

In still another exemplary embodiment of the present subject matter, a method for assembling an acoustic core of a gas turbine engine is provided. The method comprises applying an adhesive to at least one of a first mating surface of a first attenuation section and a second mating surface of a second attenuation section; aligning a first engagement feature of the first mating surface with a second engagement feature of the second mating surface; and pressing together the second mating surface and the first mating surface to join the second attenuation section to the first attenuation section. The first attenuation section comprises a first plurality of attenuation members integrally formed with a first mating wall that defines the first mating surface. The second attenuation section comprises a second plurality of attenuation members integrally formed with a second mating wall that defines the second mating surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 provides a schematic cross-section view of an exemplary gas turbine engine according to various embodiments of the present subject matter.

FIG. 2 provides a schematic top view of a first attenuation section joined to a second attenuation section to form at least a portion of an acoustic core, according to an exemplary embodiment of the present subject matter.

FIG. 3 provides a schematic top view of a first attenuation section joined to a second attenuation section to form at least a portion of an acoustic core, with each of the first and second attenuation sections having complementary mating geometry, according to an exemplary embodiment of the present subject matter.

FIG. 4 provides a schematic side view of a first attenuation section joined to a second attenuation section to form at least a portion of an acoustic core, according to an exemplary embodiment of the present subject matter.

FIG. 5 provides a schematic three-dimensional view of a first attenuation section joined to a second attenuation section to form at least a portion of an acoustic core, according to an exemplary embodiment of the present subject matter.

FIG. 6 provides a flow chart illustrating a method for assembling an acoustic core, according to an exemplary embodiment of the present subject matter.

FIG. 7 provides a flow chart illustrating a method for forming an acoustic core, according to an exemplary embodiment of the present subject matter.

### DETAILED DESCRIPTION

Reference will now be made in detail to present embodiments of the present subject matter, one or more examples of which are illustrated in the accompanying drawings. The detailed description uses numerical and letter designations to refer to features in the drawings. Like or similar designations in the drawings and description have been used to refer to like or similar parts of the present subject matter.

The word “exemplary” is used herein to mean “serving as an example, instance, or illustration.” Any implementation described herein as “exemplary” is not necessarily to be construed as preferred or advantageous over other implementations.

As used herein, the terms “first,” “second,” “third,” etc. may be used interchangeably to distinguish one component from another and are not intended to signify location or importance of the individual components.

The terms “forward” and “aft” refer to relative positions within a gas turbine engine or vehicle, and refer to the normal fluid flow path through the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

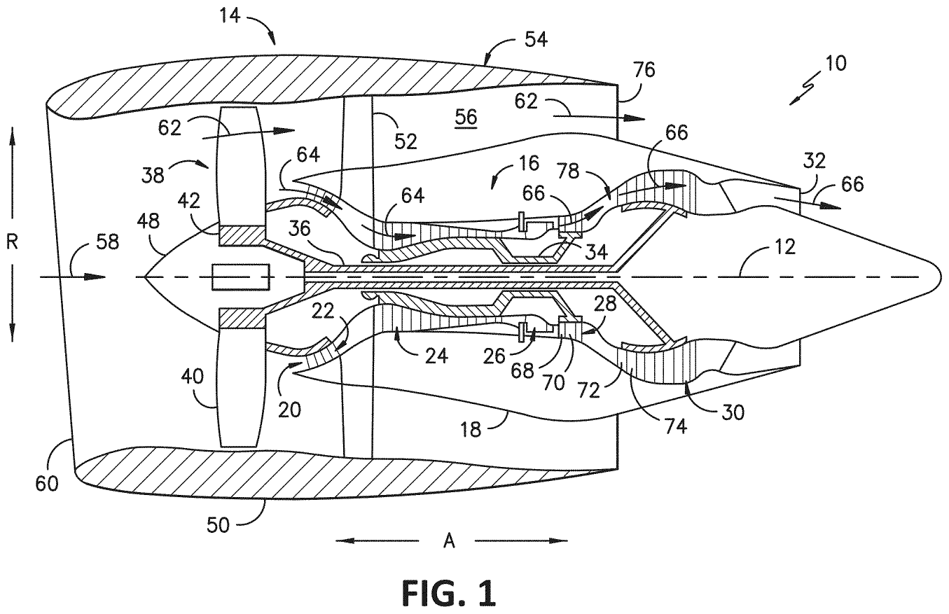

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference) and a radial direction R. In general, the turbofan engine 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the depicted embodiment, fan section 14 includes a fan 38 having a plurality of fan blades 40 coupled to a disk 42 in a spaced apart manner. As depicted, fan blades 40 extend outward from disk 42 generally along the radial direction R. The fan blades 40 and disk 42 are together rotatable about the longitudinal axis 12 by LP shaft 36. In some embodiments, a power gear box having a plurality of gears may be included for stepping down the rotational speed of the LP shaft 36 to a more efficient rotational fan speed.

Referring still to the exemplary embodiment of FIG. 1, disk 42 is covered by rotatable front nacelle 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass airflow passage 56 therebetween.

During operation of the turbofan engine 10, a volume of air 58 enters turbofan engine 10 through an associated inlet 60 of the nacelle 50 and/or fan section 14. As the volume of air 58 passes across fan blades 40, a first portion of the air 58 as indicated by arrows 62 is directed or routed into the bypass airflow passage 56 and a second portion of the air 58 as indicated by arrows 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan engine 10, also providing propulsive thrust. The HP turbine 28, the LP turbine 30, and the jet exhaust nozzle section 32 at least partially define a hot gas path 78 for routing the combustion gases 66 through the core turbine engine 16.

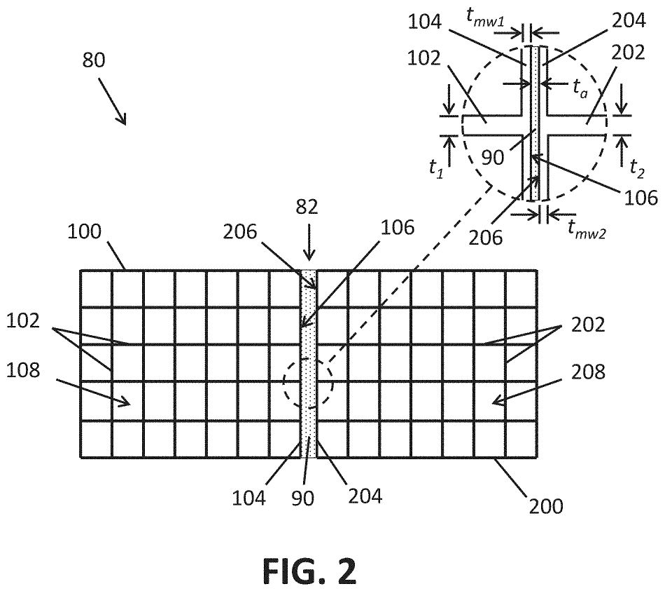

Turning to FIGS. 2-5, exemplary acoustic cores of a gas turbine engine such as turbofan engine 10 will be described. An acoustic core 80 may be used to attenuate noise from one or more engine components. For example, an acoustic core 80 may be used as an acoustic liner at the fan inlet 60 for acoustic attenuation at or near the fan section 14. An acoustic core 80 also may be used in other locations within an aircraft than the turbofan engine 10, may be used in other types of gas turbine engines, and/or may be used in other apparatus or systems for noise attenuation.

Referring specifically to FIG. 2, a first attenuation section 100 and a second attenuation section 200 have been joined to form at least a portion of an acoustic core 80. More particularly, in the depicted embodiment, the first attenuation section 100 comprises a first plurality of attenuation members 102 and a first mating wall 104. The first mating wall 104 defines a planar first mating surface 106. Further, the first mating wall 104 is integrally formed with at least a portion of the first plurality of attenuation members 102, as described in greater detail herein. Similarly, the second attenuation section 200 comprises a second plurality of attenuation members 202 and a second mating wall 204. The second mating wall 204 defines a planar second mating surface 206, and the second mating wall 204 is integrally formed with at least a portion of the second plurality of attenuation members 202.

In the exemplary embodiment of FIG. 2, the second mating wall 204 is joined to the first mating wall 104. More specifically, the second mating surface 206 interfaces with the first mating surface 106 to join the first and second mating walls 104, 204. For example, the second mating wall 204 may be joined to the first mating wall 104 with an adhesive 90. In the embodiment depicted in FIG. 2, the first and second mating surfaces 106, 206 extend in same direction and define parallel planes. A seam or interface 82 is defined where the first and second mating surfaces 106, 206 interface with one another.

The adhesive 90 may be relatively thin, e.g., the adhesive 90 may have an adhesive thickness ta of less than 0.050″ (fifty thousandths of an inch, or 1.27 mm) or, in other embodiments, less than 0.010″ (ten thousandths of an inch, or 0.25 mm). The adhesive 90 may be a double-sided tape, a film adhesive that may be heated and cured to bond to the first mating wall 104 and second mating wall 204, and/or any other suitable adhesive, such as other controlled thickness adhesive for achieving the thicknesses ta described above. Moreover, the adhesive 90 may be applied to the entire first mating surface 106, the entire second mating surface 206, or both entire surfaces 106, 206. Alternatively, the adhesive 90 may be selectively applied to one or both of the first mating surface 106 and second mating surface 206. The adhesive 90 is illustrated with stippling in the figures; the depicted pattern is for purposes of illustration only, to make the adhesive more visible in the figures.

Each of the first mating wall 106 and the second mating wall 206 also has a thickness. For instance, the first mating wall 106 may have a first mating wall thickness t_{mw1} less than 0.100″ (one hundred thousandths of an inch, or 2.54 mm). In other embodiments, the first mating wall thickness t_{mw1} may be less than 0.050″ (fifty thousandths of an inch, or 1.27 mm), and in still other embodiments, the first mating wall thickness t_{mw1} may be less than 0.030″ (thirty thousandths of an inch, or 0.76 mm). Similarly, the second mating wall 206 may have a second mating wall thickness t_{mw2} less than 0.100″ (one hundred thousandths of an inch, or 2.54 mm). In other embodiments, the second mating wall thickness t_{mw2} may be less than 0.050″ (fifty thousandths of an inch, or 1.27 mm), and in still other embodiments, the second mating wall thickness t_{mw2} may be less than 0.030″ (thirty thousandths of an inch, or 0.76 mm). It will be appreciated that the seam or the interface 82 between the first and second attenuation sections 100, 200 may affect the acoustic dampening effects of the acoustic core 80. For example, a thicker seam 82 may be worse for acoustic attenuation than a thinner seam 82, such that it may be desirable to minimize the thickness of one or more of the first mating wall 104, the second mating wall 204, and the adhesive 90 (e.g., minimize each of the first mating wall thickness the second mating wall thickness t_{mw2}, and the adhesive thickness ta) to minimize the overall thickness of the seam or interface 82 between the spliced attenuation sections 100, 200. Moreover, in some embodiments, the first mating wall thickness t_{rawl} may be less than a thickness t₁ of each of the first plurality of attenuation members 102, and the second mating wall thickness t_{mw2} may be less than a thickness t₂ of each of the second plurality of attenuation members 202.

Further, it will be understood that each mating wall 104, 204 may be included in its respective attenuation section 100, 200 specifically for splicing together the attenuation sections 100, 200 to form the acoustic core 100. As such, each mating wall 104, 204 may form at least a portion of the perimeter of its respective attenuation section 100, 200, and each mating wall 104, 204 may be sufficiently rigid to effectively splice together the two attenuation sections 100, 200 while being thin walls as described herein. For example, each of the first mating wall 104 and second mating wall 204 may have a stiffness value or modulus of elasticity greater than 10,000 PSI (ten thousand pounds per square inch, or 69 MPa). Thus, although in some embodiments the first and second mating walls 104, 204 may be of a similar thickness to the adhesive 90 joining the walls 104, 204 together, the mating walls 104, 204 may be stiffer or more rigid than the adhesive 90. The rigidity or stiffness of the first and second mating walls 104, 204 may help support their respective attenuation sections 100, 200 at the interface 82 between the first attenuation section 100 and the second attenuation section 200.

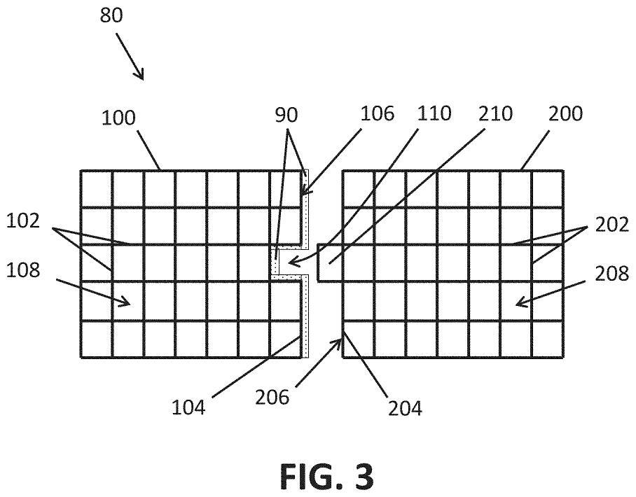

Referring now to FIG. 3, each of the first attenuation section 100 and the second attenuation section 200 may include one or more engagement features that, e.g., may provide assurance that the sections 100, 200 are assembled correctly. For instance, as shown in the exemplary embodiments of FIGS. 2 and 3, the first plurality of attenuation members 102 define a first plurality of cells 108, and the second plurality of attenuation members 202 define a second plurality of cells 208. In the depicted embodiments, each of the first plurality of cells 108 and the second plurality of cells 208 are generally cube shaped, but the cells 108, 208 may have any suitable shape, such as a honeycomb or other shape. As shown in FIG. 3, the first mating wall 104 may have a first geometry 110, and the second mating wall 204 may have a second geometry 210. In the embodiment of FIG. 3, the second geometry 210 is complementary to the first geometry 110 to facilitate joining the second mating wall 204 to the first mating wall 104. As such, the first geometry 110 also may be referred to as a first engagement feature, and the second geometry 210 may be referred to as a second engagement feature.

More particularly, in FIG. 3, the first geometry 110 is a notch such that the first mating wall 104 defines a notch 110. The notch 110 is recessed inward with respect to the first mating surface 106. As further illustrated in FIG. 3, the second geometry 210 is a protrusion such that the second mating wall 204 defines a protrusion 210. The protrusion 210 protrudes or extends outward from the second mating surface 206. The protrusion 210 is received in the notch 110 when the second mating wall 204 is joined to the first mating wall 104. That is, the first geometry 110 of the first attenuation section 100 (notch 110 in the depicted embodiment) may be configured to receive the second geometry 210 of the second attenuation section 200 (protrusion 210 in the depicted embodiment) when the first attenuation section 100 is spliced together with the second attenuation section 200. As previously described, locating the engagement feature of one attenuation section (e.g., the protrusion 210 of section 200) within the engagement feature of the other attenuation section (e.g., the notch 110 of section 100) may help during assembly of the acoustic core 80 by indicating that the attenuation sections are correctly aligned and assembled. In exemplary embodiments, the notch 110 has a notch shape and the protrusion 210 has a protrusion shape, and the notch shape is complementary to the protrusion shape, e.g., to help ensure the protrusion 210 is received in the notch 110 to engage the second attenuation section 200 with the first attenuation section 100 along the mating walls 204, 104.

As previously described, the cells 108, 208 of their respective attenuation section 100, 200 may have any suitable shape, and in the depicted embodiment of FIG. 3, the cells 108, 208 each are cube shaped. Similarly, the protrusion 210 is shaped like a cube, or is cube shaped, and the notch 110 has a complementary cubic shape. More generally, in exemplary embodiments, the protrusion 210 may have a polyhedral shape, and the notch 110 may be shaped complementary to the protrusion 210, i.e., the notch 110 may be defined such that its shape is complementary to the polyhedral shape of the protrusion 210. It will be appreciated that, generally, a polyhedron is a three-dimensional shape with planar polygonal faces, straight edges, and sharp corners or vertices. Of course, the protrusion 210 and the complementary shaped notch 110 may have other non-polyhedral shapes or forms as well. Further, the protrusion 210 and notch 110 may have generally the same shape as one or both of the cells 108, 208 or may be shaped differently from one or both of the cells 108, 208.

FIG. 3 also illustrates that the adhesive 90 may be disposed on the first mating surface 106 and/or the second mating surface 206 such that the adhesive 90 follows the contour of the first mating wall 104 and/or the second mating wall 204. For instance, the adhesive 90 may be disposed within the notch 110 and/or may be disposed on the protrusion 210. In the depicted embodiment of FIG. 3, the adhesive 90 is disposed along the first mating wall 104 such that the adhesive 90 lines the cube shaped notch 110 as well as the remaining planar portions of the first mating surface 106.

In the exemplary embodiment of FIG. 3, the first mating wall 104 includes one engagement feature, i.e., notch 110, and the second mating wall 204 includes one engagement feature, i.e., protrusion 210. The remainder of each mating wall 104, 204 is a flat or planar surface. In other embodiments, the first mating wall 104 may include any number of engagement features, e.g., zero or no engagement features as shown in FIG. 2 or more than one engagement feature, and the second mating wall 204 may include any number of engagement features, e.g., zero or no engagement features as shown in FIG. 2 or more than one engagement feature. In exemplary embodiments, the portion of each of the first mating wall 104 and the second mating wall 204 that does not define an engagement feature may be generally flat or planar. Additionally or alternatively, each of the first mating wall 104 and the second mating wall 204 may have a contour such that the contour of the first mating wall 104 is complementary to the contour of the second mating 204 to facilitate splicing together the first and second attenuation sections 100, 200.

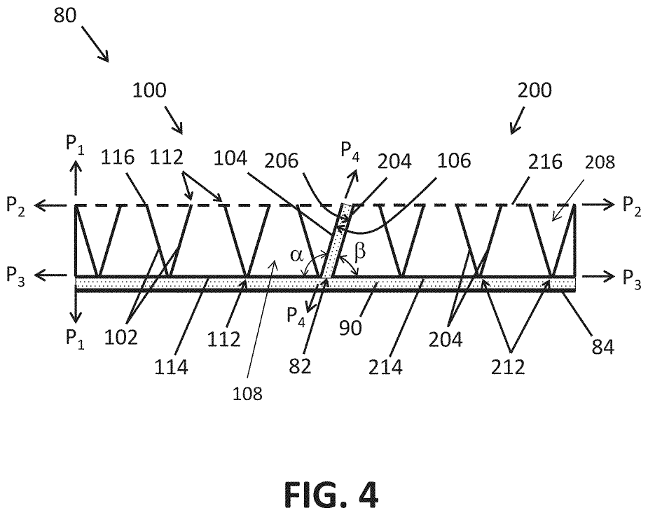

Turning to FIG. 4, in some embodiments, the mating wall of an attenuation section may be angled relative to the remainder of the attenuation section. More particularly, in FIGS. 2 and 3, the first and second mating walls 104, 204 are each perpendicular walls with respect to the other perimeter walls or boundaries of their respective attenuation sections 100, 200. In the exemplary embodiment of FIG. 4, each of the first mating wall 104 and the second mating wall 204 is angled with respect to the remaining boundaries of the respective attenuation section 100, 200. For example, considering the two-dimensional section view shown in FIG. 4, the first plurality of attenuation members 102 may have ends 112 that define a first plane P₁, a second plane P₂, and a third plane P₃; the first mating wall 104 defines a fourth plane P₄ to complete the boundaries of the first attenuation section 100 having a rectangular cross-section. In FIG. 4, the first plane P₁, second plane P₂, third plane P₃, and first mating wall 104 (defining the fourth plane P₄) define a perimeter of the first attenuation section 100. In exemplary embodiments, the first mating wall 104 is disposed at a non-orthogonal angle α with respect to at least one of the first plane P₁, second plane P₂, and third plane P₃. In the depicted embodiment, the first mating wall 104 is disposed at a non-orthogonal angle with respect to each of the first plane P₁, second plane P₂, and third plane P₃. For example, as shown in FIG. 4, the first mating wall 104 is disposed at a non-orthogonal angle α with respect to the third plane P₃. Similarly, the second mating wall 204 is disposed at a non-orthogonal angle with respect to the boundary planes defined by the ends 212 of the second plurality of attenuation members 202. For instance, in FIG. 4, the second mating wall 204 is disposed at a non-orthogonal angle θ with respect to the third plane P₃, which is defined in part by the ends 212 of the second plurality of attenuation members 202.

Keeping with FIG. 4, in some embodiments, one or more attenuation sections may include more than one mating wall. More particularly, in FIG. 4, the first attenuation section 100 includes first mating wall 104 and third mating wall 114, which are each integrally formed with at least a portion of the first plurality of attenuation members 102, and the second attenuation section 200 includes second mating wall 204 and fourth mating wall 214, which are each integrally formed with at least a portion of the second plurality of attenuation members 202. It will be appreciated that each of the third mating wall 114 and fourth mating wall 214 may be configured as described herein with respect to the first mating wall 104 and second mating wall 204. For example, each of the third mating wall 114 and fourth mating wall 214 may be relatively thin support layers for splicing the respective attenuation section 100, 200 together with another attenuation section or another segment of the acoustic core 80. More specifically, the third mating wall 114 may have a thickness t_{mw3} and the fourth mating wall 214 may have a thickness t_{mw4}, and each thickness t_{mw3}, t_{mw4} may be the same as or similar to the thickness t_{mw1} of the first mating wall 104 and/or the thickness t_{mw2} of the second mating wall 204. That is, the thicknesses t_{mw3}, t_{mw4} of the third and fourth mating walls 114, 214 may be within the ranges stated herein for the thicknesses t_{mw1}, t_{mw2} of the first and second mating walls 104, 204.

The third and fourth mating walls 114, 214 may be configured similarly to the first and second mating walls 104, 204 in other ways as well. For instance, the third mating wall 114 and/or the fourth mating wall 214 may define an engagement feature, such as a notch or a protrusion, for ensuring proper assembly with an adjacent component, such as another attenuation section or another component of the acoustic core 80. For example, the third mating wall 114 and the fourth mating wall 214 may be integral support layers (i.e., walls 114, 214 may be integrally formed with the attenuation members 102, 202 of the respective attenuation section 100, 200) that enable bonding of the relatively thin mating walls 114, 214 with components such as a backsheet 84 of the acoustic core. The relatively thin mating walls 104, 114, 204, 214 may be configured to avoid print-through of the pattern of the acoustic core cells (e.g., cells 108, 208) on structures such as the backsheet 84 or a cavity to which the attenuation sections 100, 200 are joined. Moreover, each of the third mating wall 114 and the fourth mating wall 214 may include a generally planar mating surface, as described herein with respect to the first and second mating walls 104, 204, and the respective mating wall 114, 214 may mate or join with another attenuation section or other component along its mating surface. Further, each attenuation section (such as attenuation sections 100, 200) of the acoustic core 80 may include any suitable number of mating walls, e.g., one, two, or more than two mating walls, and each mating wall of an attenuation section may be configured as described herein with respect to the first and second mating walls 104, 204.

As further illustrated in FIG. 4, each attenuation section 100, 200 may include a facesheet that defines a flow surface of the acoustic core 80. More specifically, the first attenuation section 100 may include a first facesheet 116, and the second attenuation section 200 may include a second facesheet 216. Each of the first and second facesheets 116, 216 may be perforated (i.e., may define a plurality of openings therein) and, with the first and second pluralities of cells 108, 208, may provide a geometric effect for acoustic attenuation. That is, sound waves may enter through the perforations or openings in the first and second facesheets 116, 216 and may be dampened through their interaction with the first and second pluralities of attenuation members 102, 202. Moreover, the mating walls 104, 114, 204, 214 also may be referred to as facesheets, as they form a face of the respective attenuation section 100, 200.

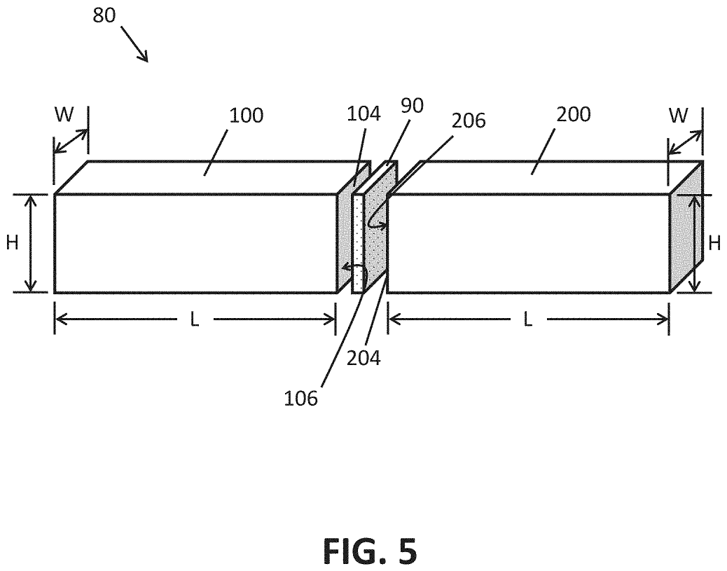

Referring now to FIG. 5, each of the first attenuation section 100 and second attenuation section 200, as well as the acoustic core 80, may be a three-dimensional structure. As shown in FIG. 5, each attenuation section 100, 200 has a length L, width W, and height H. Each mating wall 104, 114, 204, 214 defines a plane (e.g., plane P₄) extending along two of the length L, width W, and height H of the attenuation section 100, 200. Further, as described herein, each mating wall 104, 114, 204, 214 defines a boundary of the respective attenuation section 100, 200. For instance, in the depicted embodiment of FIG. 5, the first mating wall 104 extends along the width W from a first side 118 to a second side 120 of the first attenuation section 100 and along the height H from a first end 122 to a second end 124 of the first attenuation section 100. Accordingly, at the boundary defined by the first mating wall 104 in FIG. 5, the first attenuation section 100 is not an open cell structure, but the first mating wall 104 defines a planar boundary of the first attenuation section 100.

As previously discussed, it will be appreciated that an attenuation section of the acoustic core 80, such as the first attenuation section 100 and/or the second attenuation section 200, may comprise more than one mating surface. For example, multiple attenuation sections may be joined to one attenuation section via multiple sides of the one attenuation section. Additionally or alternatively, more than one attenuation section may be joined to one mating surface of an attenuation section. For instance, the second mating surface 206 of the second attenuation section 200 may be joined to the first mating surface 106 and a third mating surface of a third attenuation section (not shown) also may be joined to the first mating surface 106, where the mating surfaces may be joined together using an adhesive 90 or other suitable attachment mechanism as described herein.

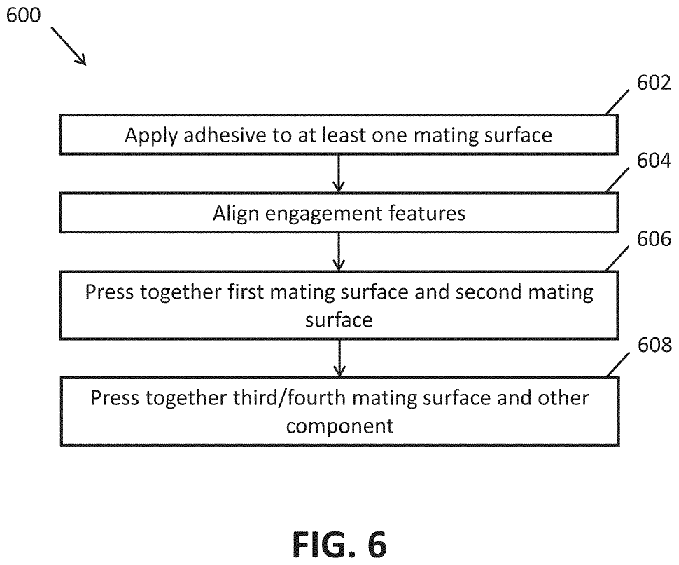

Turning to FIG. 6, the present subject matter also encompasses methods for assembling an acoustic core of a gas turbine engine, such as acoustic core 80, which may be installed in turbofan engine 10. As shown at 602 in FIG. 6, an exemplary method 600 may include applying an adhesive 90 to at least one of a first mating surface 106 of a first attenuation section 100 and a second mating surface 106 of a second attenuation section 200. That is, the adhesive 90 may be applied to only the first mating surface 106, only the second mating surface 206, or both the first and second mating surfaces 106, 206. Further, the adhesive 90 may be applied over an entire surface 106, 206 or may be selectively applied to at least one of the surfaces 106, 206 such that the adhesive 90 does not cover the entire surface 106, 206. It will be appreciated that, as described in greater detail herein, the first attenuation section 100 comprises a first plurality of attenuation members 102 that are integrally formed with a first mating wall 104 that defines the first mating surface 106, and the second attenuation section 200 comprises a second plurality of attenuation members 202 that are integrally formed with a second mating wall 204 that defines the second mating surface 206. Moreover, it will be understood that the second attenuation section 200 is separate from the first attenuation section 100, i.e., the second attenuation section 200 is formed separately from the first attenuation section 100.

As illustrated at 604 in FIG. 6, the method 600 may include aligning a first engagement or alignment feature 110 of the first mating surface 106 with a second engagement or alignment feature 210 of the second mating surface 206.

Alternatively, in some embodiments of the first and second attenuation sections 100, 200, no engagement features may be provided. Accordingly, aligning the engagement features 110, 210 as shown at 604 may be omitted in embodiments in which the first and second attenuation sections 100, 200 do not include engagement features. Moreover, as shown at 606, the method 600 may comprise pressing together the second mating surface 206 and the first mating surface 106 to join the second attenuation section 200 to the first attenuation section 100.

As described herein, more than one attenuation section may be joined to a given attenuation section. For example, in addition to joining the second attenuation section 200 to the first attenuation section 100, a third attenuation section may be joined to either the first attenuation section 100 or the second attenuation section 200. More particularly, the third attenuation section may be joined at either the first mating surface 106 or another mating surface of the first attenuation section 100, or the third attenuation section may be joined at either the second mating surface 206 or another mating surface of the second attenuation section 200. Further, it will be understood that each of the first attenuation section 100 and second attenuation 200 may have one or more additional attenuation sections joined thereto. Moreover, the attenuation sections may be joined or spliced together using the adhesive 90 as described herein.

As a result, in some embodiments, portions of the method 600 may be repeated as necessary to assemble more than two attenuation sections. For instance, at 602, the adhesive 90 may be applied to two or more mating surfaces. Then, as shown at 604 and 606, the engagement features of a first pair of mating surfaces may be aligned and the first pair of mating surface may be pressed together to join the first pair of mating surfaces. Next, the portions of method 600 shown at 604 and 606 may be repeated for a second pair of mating surfaces, i.e., the engagement features of the second pair of mating surfaces may be aligned and the second pair of mating surface may be pressed together to join the second pair of mating surfaces. Of course, as described herein, aligning the engagement features as illustrated at 604 may be omitted for mating surfaces that do not include engagement features.

Further, as described above, at least one attenuation section (such as at least one of the first attenuation section 100 and second attenuation section 200) may include a mating surface that is joined to a component other than an attenuation section. As an example, at 602, the method 600 may include applying adhesive 90 to a mating surface defined by a third mating wall 114 of the first attenuation section 100 and/or to a mating surface defined by a fourth mating wall 214 of the second attenuation section 200. Then, as shown at 608 in FIG. 6, the method 600 may include pressing together the mating surface of the third mating wall 114 and/or the mating surface of the fourth mating wall 214 with a component, such as a backsheet 84 of the acoustic core 80. Of course, rather than applying the adhesive 90 to the mating surfaces of the third and/or fourth mating walls 114, 214, the adhesive 90 may be applied to the other component, e.g., the backsheet 84. In other embodiments, the adhesive 90 may be applied to both the mating surfaces and the other component, e.g., the backsheet 84. One or both of the first and second attenuation sections 100, 200, and/or other attenuation sections forming the acoustic core 80, may be joined to one or more other components as well.

The present subject matter further encompasses methods for forming an acoustic core of a gas turbine engine, e.g., the acoustic core 80. For example, the first plurality of attenuation members 102 and the first mating wall 104 may be integrally formed by any suitable process, e.g., an additive manufacturing process. Such formation may allow the mating surface 106 to be built as part of the first attenuation section 100—and, therefore, as part of the acoustic core 80—and to be a well-matched integral feature of the first attenuation section 100.

In general, the exemplary embodiments of the acoustic core 80, including the first attenuation section 100 and the second attenuation section 200, described herein may be manufactured or formed using any suitable process. However, in accordance with several aspects of the present subject matter, each single unit attenuation section, e.g., first attenuation section 100 and second attenuation section 200, may be formed using an additive-manufacturing process, such as a 3D printing process. The use of such a process may allow each attenuation section to be formed integrally, as a single monolithic component, or as any suitable number of sub-components. In particular, the manufacturing process may allow each attenuation section 100, 200 to be integrally formed and include a variety of features not possible when using prior manufacturing methods. For example, the additive manufacturing methods described herein enable the manufacture of attenuation sections having any suitable size and shape with one or more relatively thin mating surfaces, as well as other features which were not possible using prior manufacturing methods. Some of these novel features are described herein.

As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For instance, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

In addition to using a direct metal laser sintering (DMLS) or direct metal laser melting (DMLM) process where an energy source is used to selectively sinter or melt portions of a layer of powder, it should be appreciated that according to alternative embodiments, the additive manufacturing process may be a “binder jetting” process. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. The liquid binding agent may be, for example, a photo-curable polymer or another liquid bonding agent. Other suitable additive manufacturing methods and variants are intended to be within the scope of the present subject matter.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For instance, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

Moreover, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed that have different materials and material properties for meeting the demands of any particular application. Further, although additive manufacturing processes for forming the components described herein are described in detail, it should be appreciated that in alternate embodiments, all or a portion of these components may be formed via casting, machining, injection or compression molding, extrusion, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example, a three-dimensional computer model, of the component. Accordingly, a three-dimensional design model of the component may be defined prior to manufacturing. In this regard, a model or prototype of the component may be scanned to determine the three-dimensional information of the component. As another example, a model of the component may be constructed using a suitable computer aided design (CAD) program to define the three-dimensional design model of the component.

The design model may include 3D numeric coordinates of the entire configuration of the component including both external and internal surfaces of the component. For example, the design model may define the body, the surface, and/or internal passageways such as openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The plurality of successive cross-sectional slices together form the 3D component. The component is then “built-up” slice-by-slice, or layer-by-layer, until finished.

In this manner, the components described herein may be fabricated using the additive process, or more specifically each layer is successively formed, e.g., by fusing or polymerizing a plastic using laser energy or heat or by sintering or melting metal powder. For instance, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. In other embodiments, a fused deposition method (FDM) type of additive manufacturing process may be used, where extruded polymer filaments are deposited layer by layer and the temperature of the extruded polymer fuses successive layers of material. The build material may be formed by any suitable powder or material selected for enhanced strength, durability, and useful life, particularly at high temperatures.

Each successive layer may be, for example, between about 10 μm and 300 μm, although the thickness may be selected based on any number of parameters and may be any suitable size according to alternative embodiments. Therefore, utilizing the additive formation methods described above, the components described herein may have cross sections as thin as one thickness of an associated powder or filament layer, e.g., 10 μm, utilized during the additive formation process.

In addition, utilizing an additive process, the surface finish and features of the components may vary as needed depending on the application. For instance, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer that corresponds to the part surface, then allowing, for instance, heat exchanger performance optimization. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

Notably, in exemplary embodiments, several features of the components described herein were previously not possible due to manufacturing restraints. However, the present inventors have advantageously utilized current advances in additive manufacturing techniques to develop exemplary embodiments of such components generally in accordance with the present disclosure. While the present disclosure is not limited to the use of additive manufacturing to form these components generally, additive manufacturing does provide a variety of manufacturing advantages, including ease of manufacturing, reduced cost, greater accuracy, etc.

In this regard, utilizing additive manufacturing methods, even multi-part components may be formed as a single piece of continuous material (e.g., polymer or metal) and may thus include fewer sub-components and/or joints compared to prior designs. The integral formation of these multi-part components through additive manufacturing may advantageously improve the overall assembly process. For instance, the integral formation reduces the number of separate parts that must be assembled, thus reducing associated time and overall assembly costs. Additionally, existing issues with, for example, leakage and joint quality between separate parts may advantageously be reduced, whereas overall performance may be increased.

Also, the additive manufacturing methods described above enable much more complex and intricate shapes and contours of the components described herein. For example, such components may include thin additively manufactured layers and unique internal geometries, such as thin mating walls and unique cell geometries. In addition, the additive manufacturing process enables the manufacture of a single component having different materials such that different portions of the component may exhibit different performance characteristics. The successive, additive nature of the manufacturing process enables the construction of these novel features. As a result, the components described herein may exhibit improved performance and reliability.

Now that the construction and configuration of the acoustic core 80 according to an exemplary embodiment of the present subject matter has been presented, an exemplary method 700 is provided for forming an acoustic core according to an exemplary embodiment of the present subject matter. Method 700 can be used by a manufacturer to form the acoustic core 80, or any other suitable acoustic core or liner. It should be appreciated that the exemplary method 700 is discussed herein only to describe exemplary aspects of the present subject matter and is not intended to be limiting.

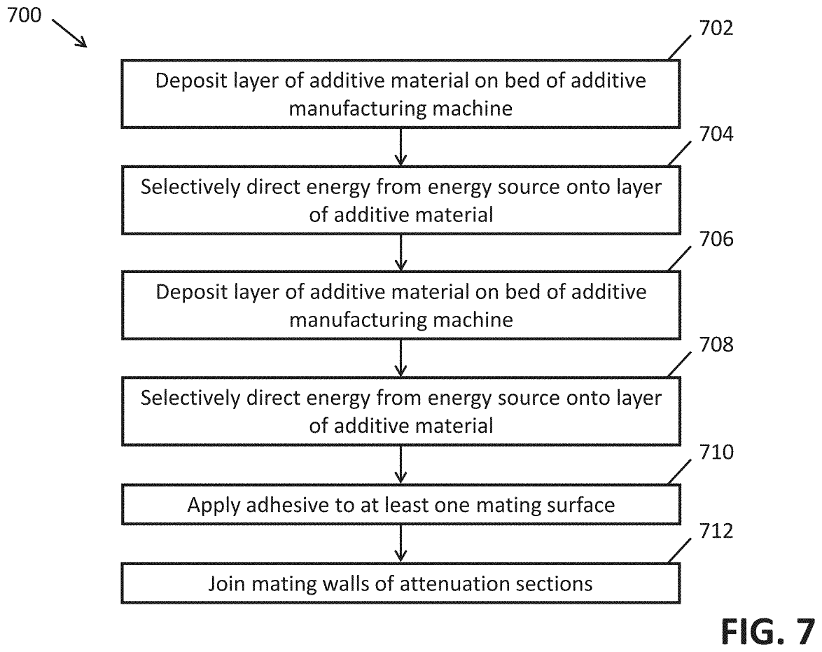

Referring now to FIG. 7, as shown at 702, the method 700 includes depositing a layer of additive material on a bed of an additive manufacturing machine. The method 700 further includes, as shown at 704, selectively directing energy from an energy source onto the layer of additive material to fuse a portion of the additive material and form an attenuation section. For example, using the example from above, the fused additive material may form the first attenuation section 100.

The additively manufactured first attenuation section 100 may include a first plurality of attenuation members 102 and a first mating wall 104. The first mating wall 104 may define a first mating surface 106 and may have a first mating wall thickness t_{mw1}, which thickness t_{mw1} may be within a range described herein. The first plurality of attenuation members 102 may define a first plurality of cells 108, and the first mating wall 104 may define a first geometry 110, which in some embodiments may be a notch having a shape or configuration similar to the shape or configuration of one or more of the first plurality of cells 108. In some embodiments, the first attenuation section 100 also may include a third mating wall 114, which defines its own mating surface, and in yet other embodiments, may include a first facesheet 116 that may be perforated. Notably, the first plurality of attenuation members 102 and the first mating wall 104 are integrally formed during the additive manufacturing process such that the first plurality of attenuation members 102 and the first mating wall 104 are a single, integral component. In embodiments also including the third mating wall 114, the first plurality of attenuation members 102 and the third mating wall 114 are integrally formed during the additive manufacturing process such that the first plurality of attenuation members 102, the first mating wall 104, and the third mating wall 114 are a single, integral component. The first attenuation section 100 also may include other features as described herein.

The second attenuation section 200 may be formed in similar fashion. Keeping with FIG. 7, as shown at 706, the method 700 includes again depositing a layer of additive material on a bed of an additive manufacturing machine. The method 700 further includes, as shown at 708, selectively directing energy from an energy source onto the layer of additive material to fuse a portion of the additive material and form an attenuation section. For example, using the example from above, the fused additive material may form the second attenuation section 200.

The additively manufactured second attenuation section 200 may include a second plurality of attenuation members 202 and a second mating wall 204. The second mating wall 204 may define a second mating surface 206 and may have a second mating wall thickness t_{mw2}, which thickness t_{mw2} may be within a range described herein. The second plurality of attenuation members 202 may define a second plurality of cells 208, and the second mating wall 204 may define a second geometry 210, which in some embodiments may be a protrusion having a shape or configuration similar to the shape or configuration of one or more of the second plurality of cells 208. In exemplary embodiments, the second geometry 210 is complementary to the first geometry 110. Further, in some embodiments, the second attenuation section 200 may include a fourth mating wall 214, which defines its own mating surface, and in yet other embodiments, may include a second facesheet 216 that may be perforated. Notably, the second plurality of attenuation members 202 and the second mating wall 204 are integrally formed during the additive manufacturing process such that the second plurality of attenuation members 202 and the second mating wall 204 are a single, integral component. In embodiments also including the fourth mating wall 214, the second plurality of attenuation members 202 and the fourth mating wall 214 are integrally formed during the additive manufacturing process such that the second plurality of attenuation members 202, the second mating wall 204, and the fourth mating wall 214 are a single, integral component. The second attenuation section 200 also may include other features as described herein.

Additionally, as shown at 712 in FIG. 7, to form an acoustic core (such as acoustic core 80), the method 700 includes joining the first mating wall 104 to the second mating wall 204 to join the first attenuation section 100 and the second attenuation section 200. In some embodiments, joining the first mating wall 104 to the second mating wall 204 comprises inserting the protrusion 210 of the second mating wall 204 into the notch 110 of the first mating wall 104. Further, the first and second mating walls 104, 204 may be joined together using a suitable adhesive, such as the adhesive 90 described herein. As such, as shown at 710, the method 700 may include applying an adhesive to the first mating surface 106 and/or the second mating surface 206 prior to joining the first and second mating walls 104, 204.

FIG. 7 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 700 are explained using the acoustic core 80 as an example, it should be appreciated that these methods may be applied to manufacture any suitable acoustic core or liner. Additionally, although only an additive manufacturing method is described in detail herein, it will be understood that the first attenuation section 100, having integral attenuation members 102 and mating wall 104, and the second attenuation section 200, having integral attenuation members 202 and mating wall 204, can be formed by other suitable methods, such as casting in a suitable mold or the like.

Various embodiments of an acoustic core, a method for assembling an acoustic core, and a method for manufacturing an acoustic core are described above. Notably, the acoustic core 80 may be formed from at least two attenuation sections 100, 200 that each generally may include geometries and configurations whose practical implementations are facilitated by an additive manufacturing process, as described herein. For example, using the additive manufacturing methods described herein, the first attenuation section 100 may include a first plurality of attenuation members 102 and a first mating wall 104 that are integrally formed as a single unit, and the second attenuation section 200 may include a second plurality of attenuation members 202 and a second mating wall 204 that are integrally formed as a single unit. In exemplary embodiments, the first attenuation section 100 and the second attenuation section 200 are joined along their respective mating walls 104, 204, e.g., using a suitable adhesive. As such, it will be appreciated that each mating wall 104, 204 (as well as mating walls 114, 214 and other mating walls described herein) may be provided for the purpose of splicing together the attenuation sections 100, 200 (or joining the acoustic core 80 with one or more other components as described herein). Further, the mating walls 104, 204, 114, 214, etc. may have the configurations, features, and/or properties to facilitate splicing or joining together of components without significantly interfering with the acoustic attenuation provided by each attenuation section 100, 200, etc. By taking advantage of additive manufacturing technology, each attenuation section 100, 200 may feature a splicing or mating surface not achievable with conventional machining or casting technologies.

Accordingly, the present subject matter provides acoustic core apparatus and methods for forming an acoustic core, as well as methods for assembling an acoustic core. The acoustic core largely may be formed by an additive manufacturing process as described herein. With additive manufactured acoustic cores, mating surfaces may be created integral to the core design to allow use of an adhesive, such as a thin film adhesive or double-sided pressure sensitive tape, to splice core sections together, e.g., in place of a typically used foaming adhesive. In addition, an integral layer may be printed with a core section, e.g., along a surface away from the flow path, to enable bonding of the core section to a thin facesheet without print through. Further, a pair of mating surfaces may include complementary geometry, which may increase confidence that the mating core sections are properly aligned. The complementary geometry may be shaped to the core geometry, e.g., to the geometry of a plurality of cells forming the bulk of the core, to ensure the design is relatively uncomplicated, which may help in manufacture and/or assembly of the acoustic core. Other advantages and benefits also may be realized from these and/or other aspects of the present subject matter.

Further aspects of the invention are provided by the subject matter of the following clauses:

1. An acoustic core of a gas turbine engine comprising a first attenuation section having a first plurality of attenuation members and a first mating wall having a planar first mating surface, the first mating wall integrally formed with at least a portion of the first plurality of attenuation members, wherein the first mating wall defines a portion of a perimeter of the first attenuation section.

2. The acoustic core of any preceding clause, further comprising a second attenuation section having a second plurality of attenuation members and a second mating wall having a planar second mating surface, the second mating wall integrally formed with at least a portion of the second plurality of attenuation members, wherein the second mating wall is joined to the first mating wall, the second mating surface interfacing with the first mating surface to join the first and second mating walls.

3. The acoustic core of any preceding clause, wherein the second mating wall is joined to the first mating wall with an adhesive.

4. An acoustic core of a gas turbine engine comprising a first attenuation section having a first plurality of attenuation members and a first mating wall integrally formed with at least a portion of the first plurality of attenuation members, wherein a thickness of the first mating wall is less than a thickness of the first plurality of attenuation members; a second attenuation section having a second plurality of attenuation members and a second mating wall integrally formed with at least a portion of the second plurality of attenuation members, wherein a thickness of the second mating wall is less than a thickness of the second plurality of attenuation members; and an attachment mechanism joining the first mating wall to the second mating wall such that the first mating wall, the second mating wall and the attachment mechanism form an interface between the first and second attenuation sections.

5. The acoustic core of any preceding clause, wherein the attachment mechanism is an adhesive.

6. The acoustic core of any preceding clause, wherein the first mating wall includes a planar first mating surface and one or more first engagement features, and the second mating wall includes a planar second mating surface and one or more second engagement features, each of the one or more second engagement features having a shape that is complementary to a shape of a respective one of the one or more first engagement features such that the one or more second engagement features are received in the one or more first engagement features to align the first and second mating walls.

7. The acoustic core of any preceding clause, herein the first mating wall has a first mating wall thickness and the second mating wall has a second mating wall thickness, and wherein each of the first mating wall thickness and second mating wall thickness is less than 0.100″ (one hundred thousandths of an inch).

8. The acoustic core of any receding clause, wherein the first mating wall has a first mating wall thickness and the second mating wall has a second mating wall thickness, and wherein each of the first mating wall thickness and second mating wall thickness is less than 0.050″ (fifty thousandths of an inch).

9. The acoustic core of any preceding clause, wherein the first mating wall has a first mating wall thickness and the second mating wall has a second mating wall thickness, and wherein each of the first mating wall thickness and second mating wall thickness is less than 0.030″ (thirty thousandths of an inch).

10. The acoustic core of any preceding clause, wherein the first plurality of attenuation members define a first plurality of cells and the second plurality of attenuation members define a second plurality of cells, wherein the first mating wall has a first geometry and the second mating wall has a second geometry, and wherein the second geometry is complementary to the first geometry for joining the second mating wall to the first mating wall.

11. The acoustic core of any preceding clause, wherein the first mating wall defines a notch, the notch recessed inward with respect to the first mating surface, wherein the second mating wall defines a protrusion, the protrusion protruding outward from the second mating surface, and wherein the protrusion is received in the notch when the second mating wall is joined to the first mating wall.

12. The acoustic core of any preceding clause, wherein the protrusion has a polyhedral shape.

13. The acoustic core of any preceding clause, wherein the notch has a notch shape and the protrusion has a protrusion shape, and wherein the notch shape is complementary to the protrusion shape.

14. The acoustic core of any preceding clause, wherein the first mating wall has a stiffness value greater than 10,000 PSI (ten thousand pounds per square inch).

15. The acoustic core of any preceding clause, wherein the first plurality of attenuation members have ends that define a first plane, a second plane, and a third plane of a cross-section of the first attenuation section, wherein the first plane, second plane, third plane, and first mating wall define a perimeter of the cross-section of the first attenuation section, and wherein the first mating wall is disposed at a non-orthogonal angle with respect to at least one of the first plane, second plane, and third plane.

16. The acoustic core of any preceding clause, wherein the first mating wall has a first mating wall thickness, and wherein the first mating wall thickness is less than 0.100″ (one hundred thousandths of an inch).

17. The acoustic core of any preceding clause, wherein the first mating wall has a first mating wall thickness, and wherein the first mating wall thickness is less than 0.050″ (fifty thousandths of an inch).

18. The acoustic core of any preceding clause, wherein the first mating wall has a first mating wall thickness, and wherein the first mating wall thickness is less than 0.030″ (thirty thousandths of an inch).

19. The acoustic core of any preceding clause, further comprising a third mating wall having a planar third mating surface, the third mating wall integrally formed with at least a portion of the first plurality of attenuation members.

20. The acoustic core of any preceding clause, wherein the third mating wall defines a portion of the perimeter of the first attenuation section.

21. The acoustic core of any preceding clause, wherein the third mating wall is joined to a mating wall of a third attenuation section or to another component.

22. The acoustic core of any preceding clause, wherein the third mating wall has a third mating wall thickness, and wherein the third mating wall thickness is less than 0.100″ (one hundred thousandths of an inch).

23. The acoustic core of any preceding clause, wherein the third mating wall has a third mating wall thickness, and wherein the third mating wall thickness is less than 0.050″ (fifty thousandths of an inch).

24. The acoustic core of any preceding clause, wherein the third mating wall has a third mating wall thickness, and wherein the third mating wall thickness is less than 0.030″ (thirty thousandths of an inch).

25. The acoustic core of any preceding clause, further comprising a fourth mating wall having a planar fourth mating surface, the fourth mating wall integrally formed with at least a portion of the second plurality of attenuation members.

26. The acoustic core of any preceding clause, wherein the fourth mating wall defines a portion of a perimeter of the second attenuation section.

27. The acoustic core of any preceding clause, wherein the fourth mating wall is joined to a mating wall of a third attenuation section or to another component.

28. The acoustic core of any preceding clause, wherein the fourth mating wall has a fourth mating wall thickness, and wherein the fourth mating wall thickness is less than 0.100″ (one hundred thousandths of an inch).

29. The acoustic core of any preceding clause, wherein the fourth mating wall has a fourth mating wall thickness, and wherein the fourth mating wall thickness is less than 0.050″ (fifty thousandths of an inch).

30. The acoustic core of any preceding clause, wherein the fourth mating wall has a fourth mating wall thickness, and wherein the fourth mating wall thickness is less than 0.030″ (thirty thousandths of an inch).

31. The acoustic core of any preceding clause, wherein the acoustic core comprises a plurality of layers formed by depositing a layer of additive material on a bed of an additive manufacturing machine and selectively directing energy from an energy source onto the layer of additive material to fuse a portion of the additive material.

32. A method for forming an acoustic core of a gas turbine engine, the method comprising depositing a layer of additive material on a bed of an additive manufacturing machine and selectively directing energy from an energy source onto the layer of additive material to fuse a portion of the additive material and form a first attenuation section of the acoustic core, the first attenuation section comprising a first plurality of attenuation members and a first mating wall, wherein the first plurality of attenuation members and the first mating wall are integrally formed as a single unit.

33. The method of any preceding clause, further comprising depositing a layer of additive material on a bed of an additive manufacturing machine and selectively directing energy from an energy source onto the layer of additive material to fuse a portion of the additive material and form a second attenuation section of the acoustic core, the second attenuation section comprising a second plurality of attenuation members and a second mating wall, wherein the second plurality of attenuation members and the second mating wall are integrally formed as a single unit.

34. The method of any preceding clause, further comprising applying an adhesive to at least one of a first mating surface of the first mating wall and a second mating surface of the second mating wall.

35. The method of any preceding clause, further comprising joining the first mating wall to the second mating wall to join the first attenuation section and the second attenuation section.

36. The method of any preceding clause, wherein joining the first mating wall to the second mating wall comprises inserting a protrusion of the second mating wall into a notch of the first mating wall.

37. A method for assembling an acoustic core of a gas turbine engine, the method comprising applying an adhesive to at least one of a first mating surface of a first attenuation section and a second mating surface of a second attenuation section; aligning a first engagement feature of the first mating surface with a second engagement feature of the second mating surface; and pressing together the second mating surface and the first mating surface to join the second attenuation section to the first attenuation section, wherein the first attenuation section comprises a first plurality of attenuation members integrally formed with a first mating wall that defines the first mating surface, and wherein the second attenuation section comprises a second plurality of attenuation members integrally formed with a second mating wall that defines the second mating surface.

38. The method of any preceding clause, further comprising applying the adhesive to at least one of a third mating surface of the first attenuation section and a mating surface of a third attenuation section or of another component.

39. The method of any preceding clause, further comprising aligning a third engagement feature of the third mating surface with an engagement feature of the third attenuation section or of the other component.

40. The method of any preceding clause, further comprising pressing together the third mating surface and the mating surface of the third attenuation section or of the other component to join the first attenuation section to the third attenuation section or the other component.

41. The method of any preceding clause, wherein the first plurality of attenuation members are integrally formed with a third mating wall that defines the third mating surface.

42. The method of any preceding clause, further comprising applying the adhesive to at least one of a fourth mating surface of the second attenuation section and a mating surface of a third attenuation section or of another component.

43. The method of any preceding clause, further comprising aligning a fourth engagement feature of the fourth mating surface with an engagement feature of the third attenuation section or of the other component.

44. The method of any preceding clause, further comprising pressing together the third mating surface and the mating surface of the third attenuation section or of the other component to join the first attenuation section to the third attenuation section or the other component.

45. The method of any preceding clause, wherein the second plurality of attenuation members are integrally formed with a fourth mating wall that defines the fourth mating surface.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An acoustic core of a gas turbine engine, comprising:
a first attenuation section having a first plurality of attenuation members; and
a first mating wall having a planar first mating surface, the first mating wall integrally formed with at least a portion of the first plurality of attenuation members,
wherein the first mating wall defines a portion of a perimeter of the first attenuation section.

2. The acoustic core of claim 1, further comprising:
a second attenuation section having a second plurality of attenuation members; and
a second mating wall having a planar second mating surface, the second mating wall integrally formed with at least a portion of the second plurality of attenuation members,
wherein the second mating wall is joined to the first mating wall, the second mating surface interfacing with the first mating surface to join the first and second mating walls.

3. The acoustic core of claim 2, wherein the second mating wall is joined to the first mating wall with an adhesive.

4. The acoustic core of claim 2, wherein the first mating wall has a first mating wall thickness and the second mating wall has a second mating wall thickness, and wherein each of the first mating wall thickness and second mating wall thickness is less than 0.100″ (one hundred thousandths of an inch).

5. The acoustic core of claim 2, wherein the first mating wall has a first mating wall thickness and the second mating wall has a second mating wall thickness, and wherein each of the first mating wall thickness and second mating wall thickness is less than 0.050″ (fifty thousandths of an inch).

6. The acoustic core of claim 2, wherein the first mating wall has a first mating wall thickness and the second mating wall has a second mating wall thickness, and wherein each of the first mating wall thickness and second mating wall thickness is less than 0.030″ (thirty thousandths of an inch).

7. The acoustic core of claim 2, wherein the first plurality of attenuation members define a first plurality of cells and the second plurality of attenuation members define a second plurality of cells, wherein the first mating wall has a first geometry and the second mating wall has a second geometry, and wherein the second geometry is complementary to the first geometry for joining the second mating wall to the first mating wall.

8. The acoustic core of claim 2, wherein the first mating wall defines a notch, the notch recessed inward with respect to the first mating surface, wherein the second mating wall defines a protrusion, the protrusion protruding outward from the second mating surface, and wherein the protrusion is received in the notch when the second mating wall is joined to the first mating wall.

9. The acoustic core of claim 8, wherein the protrusion has a polyhedral shape.

10. The acoustic core of claim 1, wherein the first attenuation section includes a first facesheet, and wherein the first facesheet is perforated.

11. The acoustic core of claim 1, wherein the first mating wall has a stiffness value greater than 10,000 PSI (ten thousand pounds per square inch).

12. The acoustic core of claim 1, wherein the first plurality of attenuation members have ends that define a first plane, a second plane, and a third plane of a cross-section of the first attenuation section, wherein the first plane, second plane, third plane, and first mating wall define a perimeter of the cross-section of the first attenuation section, and wherein the first mating wall is disposed at a non-orthogonal angle with respect to at least one of the first plane, second plane, and third plane.

13. The acoustic core of claim 1, wherein the first mating wall has a first mating wall thickness, and wherein the first mating wall thickness is less than 0.050″ (fifty thousandths of an inch).

14. The acoustic core of claim 1, further comprising:
a third mating wall having a planar third mating surface, the third mating wall integrally formed with at least a portion of the first plurality of attenuation members.

15. The acoustic core of claim 1, wherein the acoustic core comprises a plurality of layers formed by:
depositing a layer of additive material on a bed of an additive manufacturing machine; and
selectively directing energy from an energy source onto the layer of additive material to fuse a portion of the additive material.

16. A method for forming an acoustic core of a gas turbine engine, the method comprising:
depositing a first layer of additive material on a bed of an additive manufacturing machine; and
selectively directing energy from an energy source onto the first layer of additive material to fuse a portion of the additive material and form a first attenuation section of the acoustic core, the first attenuation section comprising a first plurality of attenuation members and a first mating wall,
wherein the first plurality of attenuation members and the first mating wall are integrally formed as a single unit.

17. The method of claim 16, further comprising:
depositing a second layer of additive material on a bed of an additive manufacturing machine; and
selectively directing energy from an energy source onto the second layer of additive material to fuse a portion of the additive material and form a second attenuation section of the acoustic core, the second attenuation section comprising a second plurality of attenuation members and a second mating wall,
wherein the second plurality of attenuation members and the second mating wall are integrally formed as a single unit.

18. The method of claim 17, further comprising:
joining the first mating wall to the second mating wall to join the first attenuation section and the second attenuation section.

19. The method of claim 18, wherein joining the first mating wall to the second mating wall comprises inserting a protrusion of the second mating wall into a notch of the first mating wall.

20. A method for assembling an acoustic core of a gas turbine engine, the method comprising:
applying an adhesive to at least one of a first mating surface of a first attenuation section and a second mating surface of a second attenuation section;
aligning a first engagement feature of the first mating surface with a second engagement feature of the second mating surface; and
pressing together the second mating surface and the first mating surface to join the second attenuation section to the first attenuation section,
wherein the first attenuation section comprises a first plurality of attenuation members integrally formed with a first mating wall that defines the first mating surface, and
wherein the second attenuation section comprises a second plurality of attenuation members integrally formed with a second mating wall that defines the second mating surface.
